(19) United States
(12) Patent Application Publication
(10) Pub. No.: US 2011/0253114 A1
(43) Pub. Date: Oct. 20, 2011

(54) Method for Igniting a Fuel/Air Mixture of a Combustion Chamber, in Particular in an Internal Combustion Engine, by Creating a Corona Discharge

(76) Inventor: Torsten SCHREMMER, Asperg (DE)

(21) Appl. No.: 13/081,330

(22) Filed: Apr. 6, 2011

(30) Foreign Application Priority Data
Apr. 17, 2010 (DE) 10 2010 015 344.3

(51) Int. Cl. F02P 3/01

(52) U.S. Cl. 123/606

(57) ABSTRACT

The invention relates to a method for igniting a fuel/air mixture in a cyclically operating internal combustion engine comprising one or more combustion chambers (1) which are delimited by walls (2, 3, 4) that are at ground potential, using an igniter,

wherein an electrical transformer (12) having a baseline impedance (Z_{Baseline}) that is characteristic for the selected ignition system on the primary side thereof is used to excite an electric oscillating circuit (7), which is connected to a secondary winding (17) of the transformer (12) and in which an ignition electrode (5), which extends through one of the walls (2, 3, 4) delimiting the combustion chamber (1) in an electrically insulated manner, constitutes a capacitance together with the walls (2, 3, 4) of the combustion chamber (1) that are at ground potential,
and wherein the excitation of the oscillating circuit (7) is controlled such that a corona discharge (22) igniting the fuel/air mixture is created in the combustion chamber (1) at the ignition electrode (5). According to the invention, before every moment of ignition of the internal combustion engine, the electric voltage (U) applied at a primary winding (14, 15) of the transformer (12)—referred to hereinbelow as primary voltage—is increased incrementally, wherein the increments by which the primary voltage (U) is increased are selected such that the intensity of the electric current (I) flowing in the primary winding (14, 15)—referred to hereinbelow as primary current—increases incrementally due to the stepwise increase in the applied primary voltage (U) by amounts that become smaller as the impedance at the input of the transformer (12) increases, and move toward a specifiable minimum upon approaching a voltage at which a voltage breakdown—referred to hereinbelow as breakdown voltage U_{D}—occurs in the oscillating circuit (7).

The invention is directed to a method having the features indicated in the preamble of claim 1. Such a method and such a system are known from WO 2010/011838 A1.

Document WO 2004/063560 A1 discloses how a fuel/air mixture can be ignited in a combustion chamber of an internal combustion engine by a corona discharge created in the combustion chamber. For this purpose an ignition electrode extends in an electrically insulated manner through one of the walls of the combustion chamber, that are at ground potential into the combustion chamber, preferably opposite of a reciprocating piston provided in the combustion chamber. The ignition electrode constitutes a capacitance together with the walls of the combustion chamber that are at ground potential and function as counterelectrode. The combustion chamber and the contents thereof act as a dielectric. Air or a fuel/air mixture or exhaust gas is located therein, depending on which stroke the piston is engaged in.

The capacitance is a component of an electric oscillating circuit which is excited by a high-frequency voltage created using a transformer having a center tap. The transformer interacts with a switching device which applies alternately a specifiable DC voltage to the two primary windings of the transformer separated by the center tap. The secondary winding of the transformer supplies a series oscillating circuit comprising the capacitance formed by the ignition electrode and the walls of the combustion chamber. The frequency of the alternating voltage which excites the oscillating circuit and is delivered by the transformer is controlled such that it is as close as possible to the resonance frequency of the oscillating circuit. The result is a voltage step-up between the ignition electrode and the walls of the combustion chamber in which the ignition electrode is disposed. The resonance frequency is typically between 30 kilohertz and 3 megahertz, and the alternating voltage reaches values at the ignition electrode of 50 kV to 500 kV, for example.

Thus, a corona discharge can be created in the combustion chamber. The corona discharge should not break down into an arc discharge or a spark discharge. Measures are therefore implemented to ensure that the voltage between the ignition electrode and ground remains below the voltage required for a complete breakdown. For this purpose, it is known from WO 2004/063560 A1 to measure the voltage and the current intensity at the input of the transformer and, on the basis thereof, to calculate the impedance as the quotient of the voltage and the current intensity. The impedance calculated in this manner is compared to a fixed setpoint value for the impedance, which is selected such that the corona discharge can be maintained without the occurrence of a complete voltage breakdown.

This method has the disadvantage that the formation of the corona is not optimal and, in particular, an optimal size of the corona is not always attained. Specifically, the corona increases in size the closer the oscillating circuit is operated to the breakdown voltage. To ensure that the breakdown voltage is never reached, the setpoint value of the impedance that must not be exceeded must be so low that a voltage breakdown and, therefore, an arc discharge, is always prevented. A point that must be considered when specifying the setpoint value of the impedance is that the current-voltage characteristic curve of the circuit driving the transformer, which is also referred in the following as the igniter, is subject to production-related fluctuations. If structural or production-related changes are made to igniters that cause the voltage-current characteristic curve to change, it may be necessary to redetermine the setpoint value of the impedance using trials, to prevent the situation in which a corona of inadequate size is formed or, in the worst case, a corona is not formed at all.

On the basis of document WO 2010/011838 A1 it is known to control the transformer on the primary side thereof by specifying, initially at a low voltage, a setpoint impedance by determining a so-called baseline impedance at the input of the transformer. Starting at a low voltage, the voltage-current characteristic curve at the input of the transformer initially has a linear shape, which indicates that impedance remains the same: The current intensity initially increases in proportion to voltage. The baseline impedance is characteristic for the particular igniter. If a certain voltage is exceeded, the impedance increases, which is indicated by the fact that the intensity of the current measured on the primary side of the transformer is no longer proportional to the voltage, but rather increases at an increasingly slower rate as the voltage continues to increase, until a voltage breakdown occurs. In the method known from document WO 2010/011838 A1, the setpoint impedance is determined as the sum of the baseline impedance and an additional impedance. The additional impedance is increased in small increments by increasing the voltage until a spark discharge occurs. As soon as a spark discharge is detected, the additional impedance is reduced by an amount that is slightly greater than the preceding increment, in order to prevent further spark discharges and keep the oscillating circuit in resonance. In this way it is possible to hold the current intensity and voltage at the input of the transformer below the amount at which a spark discharge can occur, i.e. to limit them to an amount at which the corona reaches a maximum size.

The disadvantage of the method known from document WO 2010/011838 A1 is that the fuel/air mixture cannot be ignited by a corona discharge without spark discharges occurring from time to time, because observing the occurrence of spark discharges is the precondition for specifying the setpoint value of the impedance. However, even if a spark discharge occurs only sporadically, the result can be unideal combustion or misfirings, or even erosion of the ignition electrodes.

The object of the present invention is a method for igniting a fuel/air mixture in one or more combustion chambers using corona discharge, which allows for optimal formation of the corona and avoids the initially described disadvantages to the greatest extent possible.

This object is attained by way of a method having the features indicated in claim 1. Advantageous refinements of the invention are the subject matter of the dependent claims.

In the method according to the invention for igniting a fuel/air mixture in a cyclically operating internal combustion engine having one or more combustion chambers delimited by walls that are at ground potential, an igniter having an electric transformer, which has on the primary side thereof a baseline impedance Z_{Baseline} that is characteristic for the ignition system, is used to excite an electric oscillating circuit which is connected to a secondary winding of the transformer. In the oscillating circuit an ignition electrode, which is guided through one of the walls delimiting the combustion chamber in an electrically insulated manner and extends into the combustion chamber, forms a capacitance together with the walls of the combustion chamber that are at ground potential. The excitation of the oscillating circuit is controlled such that a corona discharge igniting the fuel/air mixture is created in the combustion chamber at the ignition electrode. For this purpose, in each cycle of the internal combustion engine, the electric voltage applied at a primary winding of the transformer—referred to hereinbelow as primary voltage—is increased incrementally, wherein the increments by which the primary voltage is increased are selected such that the intensity of the electric current flowing in the primary winding—referred to hereinbelow as primary current—increases incrementally due to the stepwise increase in the primary voltage by amounts that become smaller as the impedance on the primary side of the transformer increases, and move toward a specifiable minimum upon approaching the breakdown voltage. In this case, the breakdown voltage is understood to be the primary voltage that, when exceeded, results in the corona discharge transitioning into a spark discharge or arc discharge. The ignition system comprises the components that are necessary for the ignition by a corona discharge and which are used in the method of the present invention.

The invention has substantial advantages:
Due to the method according to the invention, the primary voltage can approach the breakdown voltage and therefore an optimal corona discharge can be attained without the need to occasionally exceed the breakdown voltage and determine the magnitude thereof.
By way of the incremental increase in voltage and determining the resulting increase in intensity of the primary current, it is possible to determine the point where one is located after every incremental increase on the U/I characteristic curve of the dependence of primary current on primary voltage. The characteristic curve has a typical shape which is characterized in that impedance is constant at low primary voltages, i.e. the intensity of the primary current is initially proportional to the primary voltage. The characteristic curve, which depicts the dependence of primary current on primary voltage, is initially a straight line, the slope of which is impedance Z=U/I. However, the impedance increases above a certain voltage U_{A}. The slope of the characteristic curve U/I increases until the breakdown voltage U_{D} is reached, and then discontinues. As the primary voltage continues to approach the breakdown voltage U_{D}, the increase in primary current becomes less and less. The method according to the invention makes use of this situation by deriving a criterium therefrom, according to which the increase in primary voltage can be reliably halted shortly before the breakdown voltage U_{D} is reached.
Due to the characteristic shape of the U/I characteristic curve, it is possible in the method according to the invention for the primary voltage to approach the breakdown voltage U_{D} up to a specifiable distance therefrom even if the absolute magnitude of the breakdown voltage U_{D} is unknown. When the method according to the invention is applied, no particular adjustments need to be made to changes in the impedance, in particular the baseline impedance, which according to the prior art make it necessary to determine the breakdown voltage U_{D} and the impedance that exists shortly before the breakdown voltage U_{D} is reached, to avoid reaching the breakdown voltage U_{Dd}. The method according to the invention does not require a fixed impedance threshold value or a fixed threshold value for the primary voltage. Instead, the method according to the invention is self-adaptive, and is capable of automatically compensating for changes in the U/I characteristic curve caused by ageing processes, manufacturing tolerances, structural or production-related changes to the igniter, pollution of the ignition electrode, temperature changes or the use of different control devices.
When the method according to the invention is applied, spark discharges or arc discharges are eliminated practically entirely during operation of the corona discharge, thereby reducing erosion of the ignition electrodes.
The approach to the breakdown voltage made possible according to the invention results in a corona of optimal size, which provides optimal conditions for ignition of the fuel/air mixture and ensures rapid propagation of the flame front.

There are several practical implementations of the method according to the invention. The specified minimum, toward which the incremental increases in intensity of the primary current move, can be zero, although it can also be a limiting value that differs from zero. The latter can be advantageous in order to meaningfully limit the increments before halting the increase of the primary voltage. Advantageously, the increase of the primary voltage is halted at the latest when the specifiable minimum of the amount by which the intensity of the primary current increases as the primary voltage is increased incrementally is reached or fallen below for the first time. Another advantageous possibility is not to halt the incremental increase in the primary voltage once a specifiable minimum is reached or fallen below, but rather as soon as a limiting value of the increase in primary current intensity is reached, wherein this limiting value is located above the stated minimum by a specifiable amount. This is recommended, in particular, if the value zero was selected as the specifiable minimum.

To excite the oscillating circuit with a high-frequency alternating voltage, a transformer is advantageously used which comprises on the primary side thereof a center tap at which two primary windings meet. They can be connected to a DC voltage source in opposite directions in alternation, and therefore the two primary windings are excited inversely in alternation, thereby inducing an alternating voltage in the secondary winding of the transformer, the frequency of which is determined by the frequency at which the two primary windings are connected in alternation to the DC voltage source. Advantageously, this frequency can be changed, thereby ensuring that the oscillating circuit on the secondary side of the transformer can be excited with the resonance frequency thereof. It is known to provide a high-frequency switch on the primary side of the transformer for this purpose, which connects the two primary windings in opposite directions in alternation to the DC voltage source provided. Documents WO 2004/063560 A1 and WO 2010/011838 A disclose additional details thereto. The excitation of the oscillating circuit is advisably discontinuous with a present frequency that is set by a control device that is adapted to the method of the present invention.

In a combustion engine, the fuel/air mixture has to be ignited in each cylinder in every motor cycle. It is also possible to cause more than one ignition process by corona discharge in each cylinder during each motor cycle. An advantage of this is that fuel can be more completely burned by a post-combustion or exhaust gas with fewer harmful contents can be achieved, for example.

There are advantageous embodiments of the method according to the invention which require knowledge of the magnitude of the baseline impedance on the primary side of the transformer. As mentioned above, this can be determined in the case of voltages having a linear U/I characteristic curve by measuring the primary voltage and the primary current, and calculating the quotient thereof. The baseline impedance is preferably determined prior to every ignition. This ensures that its value is always current.

According to a particularly advantageous embodiment of the method, the primary voltage U is increased incrementally by applying an iteration method for calculating the primary voltage Uₙ for the nth step on the basis of the primary current having intensity Iₙ₋₁, which was induced by the primary voltage Uₙ₋₁ applied in the (n−1)th step, according to the formula

Uₙ=Z_{Baseline}*Iₙ₋₁*k (1)

wherein k is greater than 1. In this manner a series of primary voltages Uₙ which converge toward the breakdown voltage U_{D} or a final value U_{B} of the primary voltage that is slightly below the breakdown voltage U_{D} is obtained, and a series of primary current intensities Iₙ is obtained, the increases of which converge toward zero.

The factor k influences the final value of the convergence, i.e. the final value U_{B} of the primary voltage that is below the breakdown voltage U_{D} and toward which the primary voltage converges. The factor k can be suitably determined in preliminary trials. The factor k must be less than or equal to the quotient of the breakdown voltage U_{D} and the product of the breakdown current I_{D} and the baseline impedance Z_{Baseiine}:

k<=U_{D}/(Z_{Baseline}−I_{D}). (3)

It can be determined for a certain engine and a corona ignition device provided therefor using preliminary trials, and can then be applied in the method according to the invention for the entire series of identical engines. The breakdown current I_{D} is intended to mean the maximum of the primary current intensity that occurs before voltage breakdown takes place.

In a piston engine, the breakdown voltage U_{D} depends on the distance between the ignition electrode and the piston or—in other words—on the position of the crankshaft or—in other words—on the ignition angle. Since the ignition of the fuel/air mixture should take place at a certain piston position or a certain ignition angle, and the latter can be changed by the engine control unit, it is advantageous to define the factor k differently for different piston positions and ignition angles. Defined values of k can be stored in a control unit as a function of one of the three parameters “piston position”, “position of the crankshaft”, and “ignition angle”, e.g. in an engine control unit that is present anyway, or in an ignition control unit which is provided separately for controlling the ignition method according to the invention. The value of k that depends on the parameter that was selected can then be applied in the formula provided for the iteration

Uₙ=Z_{Baseline}*Iₙ₋₁*k (1)

Provided the value of the selected parameter remains the same, the factor k should also remain the same.

Theoretically, the iteration method could be carried out using an infinitely large number of steps. However, the iteration method is advantageously halted when the increase Iₙ−Iₙ₋₁ in primary current intensity attained in a step n, or the increase Uₙ₊₁−Uₙ in primary voltage calculated on the basis thereof reaches or falls below a specified limiting value. This limiting value can be selected such that it defines how closely one approaches the final value U_{B} of the primary voltage in the iteration, wherein the final value U_{B} of the primary voltage is defined by suitably selecting the factor k, and is less than the breakdown voltage U_{D}.

According to another advantageous embodiment of the method, the primary voltage U is increased incrementally by applying an iteration method for calculating the primary voltage Uₙ for the nth step on the basis of the primary current having intensity Iₙ₋₁, which was induced by the primary voltage Uₙ₋₁ applied in the (n−1)th step, according to the formula

Uₙ=Z_{Baseline}*Iₙ₋₁+U_{ADD} (2)

wherein U_{ADD} is an additional voltage that is slightly lower than the difference between the breakdown voltage U_{D} and the voltage determined by the product of the baseline impedance Z_{Baseline} and the breakdown current I_{D}. The quantity U_{ADD} is preferably determined in advance in preliminary trials conducted on an engine, and is then applied for a series of identical engines comprising the same ignition electrode located in the same position.

For a piston engine, the additional voltage U_{ADD} is determined in a manner similar for factor k in the above-described embodiment of the method according to the invention as a function of the distance of the piston from the tip of the ignition electrode, or the position of the crankshaft driven by the piston, or the ignition angle. U_{ADD} can be stored and applied according to the invention for identical engines comprising the same ignition electrode located in the same position, as a function of one of these three parameters, in the equation

Uₙ=Z_{Baseline}*Iₙ₋₁+U_{ADD} (2)

wherein U_{ADD} should change only if the value of one of these parameters changes, but should otherwise remain the same.

Preferably, the additional voltage U_{ADD} is determined in preliminary trials such that it is slightly lower than the difference between the breakdown voltage U_{D} and the voltage determined by the product of the baseline impedance Z_{Baseline} and the breakdown current I_{D}. The primary voltage then converges toward a value that is only slightly lower than the breakdown voltage U_{D}. An advantage of the method is that changes in the baseline impedance are automatically compensated for, and so the method may be applied using the previously determined quantity U_{ADD} even in cases where the ignition device was structurally redesigned for engines that are otherwise identical, provided the design and placement of the ignition electrode within the combustion chamber remain unchanged.

Theoretically, the iteration method could be carried out using an infinitely large number of steps. In this embodiment of the invention, the iteration method is advantageously halted when the increase Iₙ−Iₙ₋₁ in primary current intensity attained in a step n, or the increase Uₙ₊₁−Uₙ in primary voltage calculated on the basis thereof, reaches or falls below a specified limiting value.

In a third advantageous embodiment of the invention, the primary voltage is increased by applying an iteration method incrementally from a value Uₙ to a value Uₙ₊₁, and the intensity of the resulting primary current Iₙ₊₁ is measured and compared to the current intensity Iₙ measured in the preceding step n. On the basis thereof, the mean slope of the U/I characteristic curve is determined for the dependence of the primary current on the primary voltage in the region between the nth step and the (n+1)th step, and the iteration method is halted when the mean slope determined in the last step reaches or exceeds a specified limiting value. Advantageously, the mean slope of the U/I characteristic curve is determined as

Zₐᵥ=(Uₙ₊₁−Uₙ)/(Iₙ₊₁−Iₙ) (4)

This iteration method converges as well. The limiting value that is selected determines how closely the breakdown voltage U_{D} is approached. In the simplest case, the primary voltage is increased in uniform increments. It is also possible, however, to increase the primary voltage in the non-linear part of the U/I characteristic curve by increments Uₙ₊₁−Uₙ, the size of which decreases linearly. As a result, the steps used to approach the primary voltage of the breakdown voltage become smaller as they get closer, thereby making it easier to more closely approach the breakdown voltage U_{D}.

The invention is explained in greater detail below with reference to the attached schematic drawings.

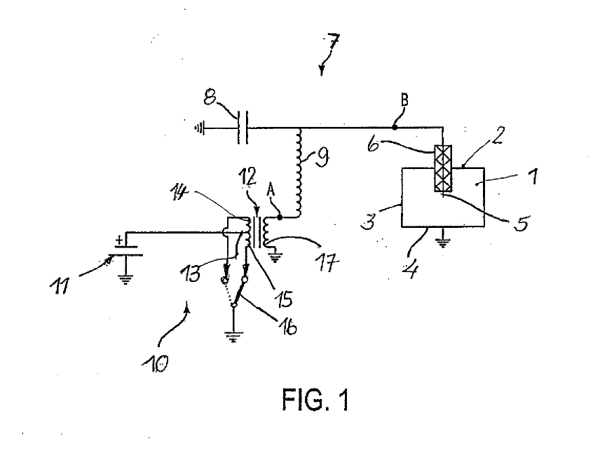

FIG. 1 shows a schematic depiction of the design of an ignition system for a vehicle engine,

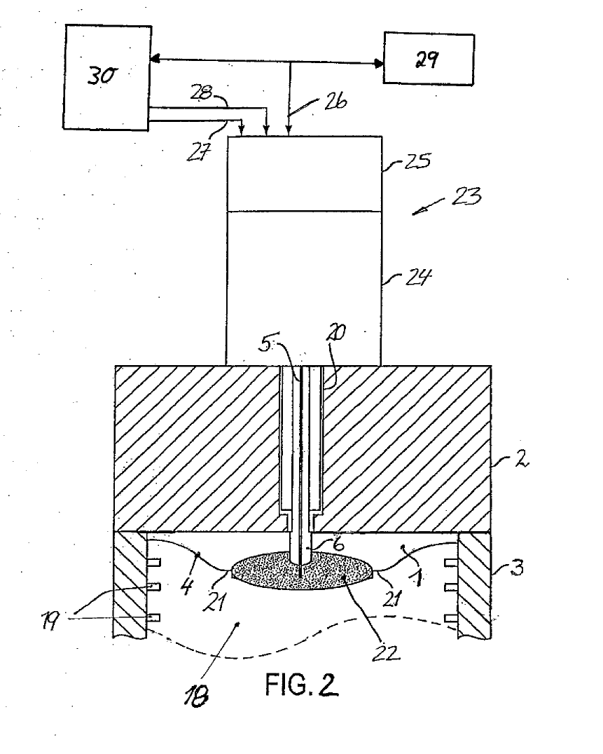

FIG. 2 shows a longitudinal cross section of a cylinder of an internal combustion engine, which is connected to the ignition system shown in FIG. 1,

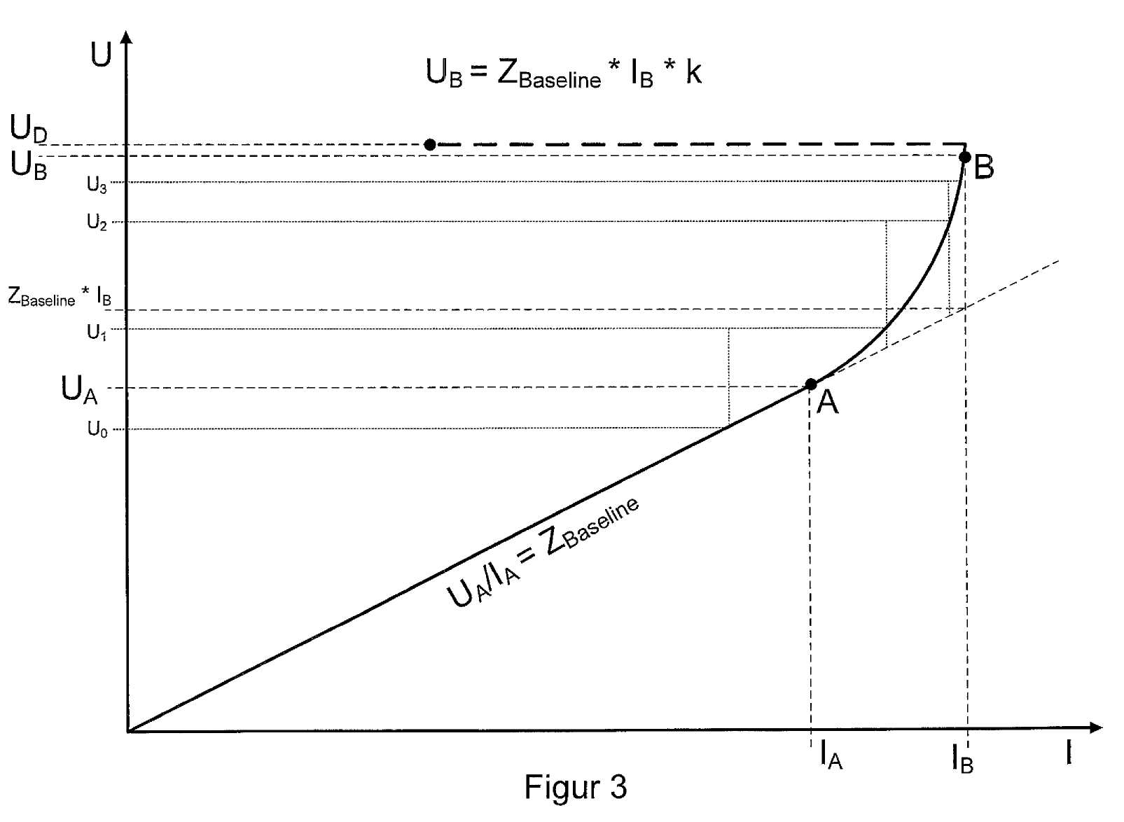

FIG. 3 shows the U/I characteristic curve at the input of the transformer, and is used to explain the calculation of a final value (setpoint voltage) of the primary voltage U_{B} using an iteration method according to formula (1),

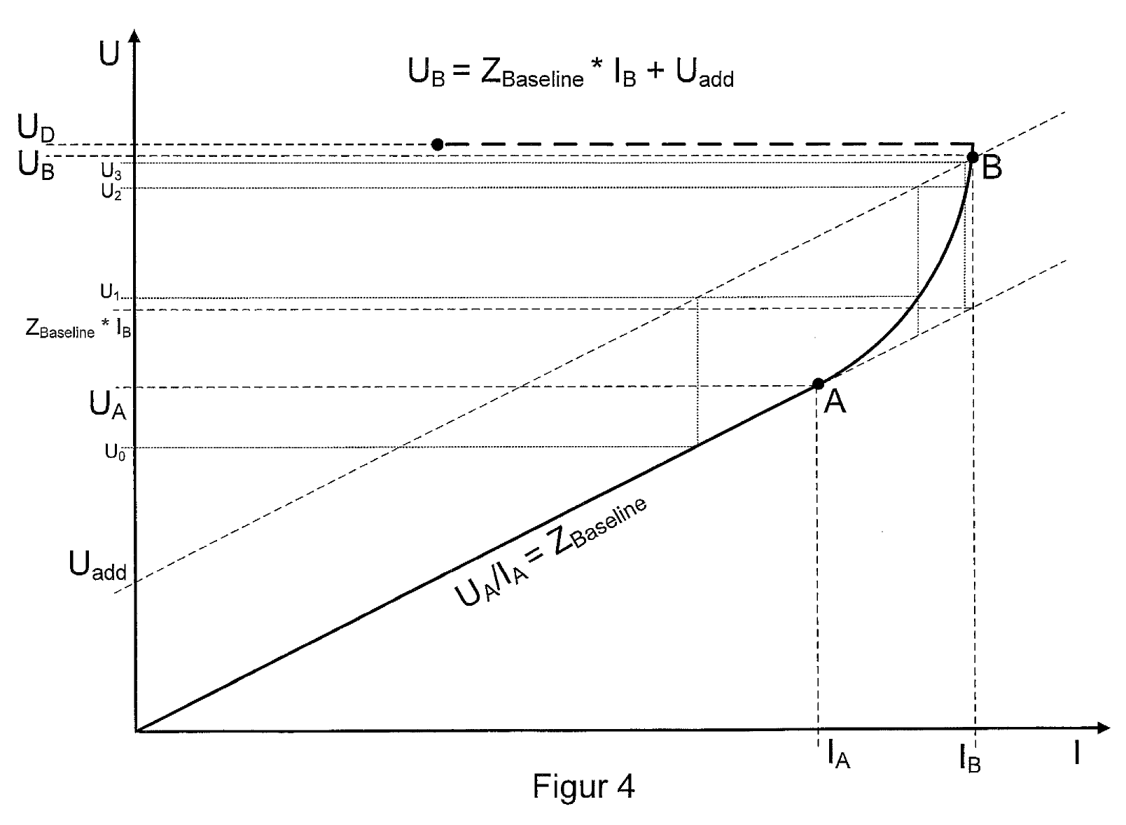

FIG. 4 shows the U/I characteristic curve at the input of the transformer 12, and is used to explain the calculation of a final value (setpoint voltage) of the primary voltage U_{B} using an iteration method according to formula (2),

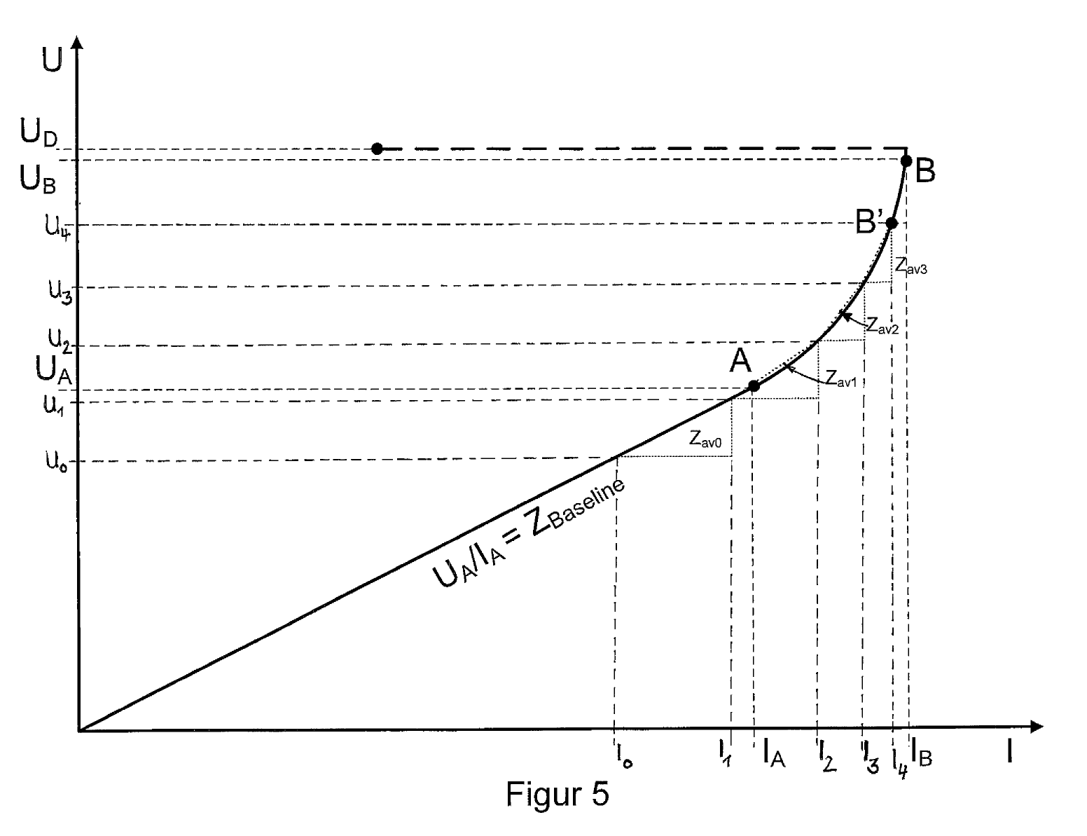

FIG. 5 show a U/I characteristic curve at the input of the transformer 12, and is used to explain how one can use an iteration method to approach a final value U_{B} of the primary voltage of the breakdown voltage by increasing the primary voltage incrementally until the slope of the U/I characteristic curve reaches or exceeds a specified limiting value,

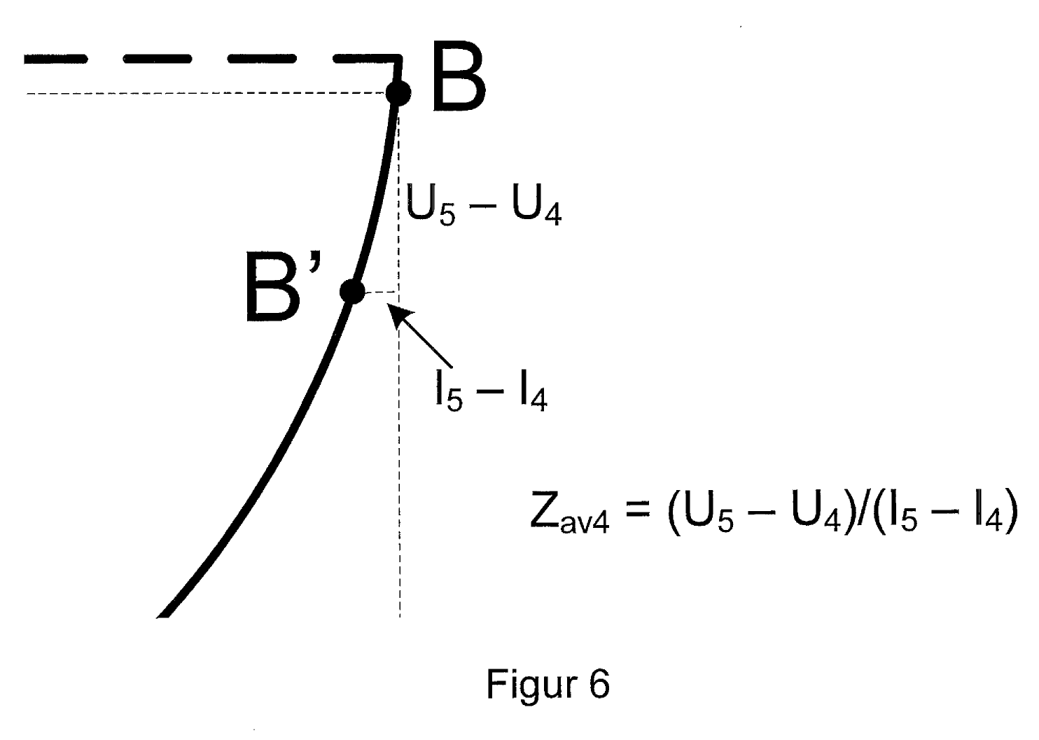

FIG. 6 shows a detail depicted in FIG. 5, in an enlarged view,

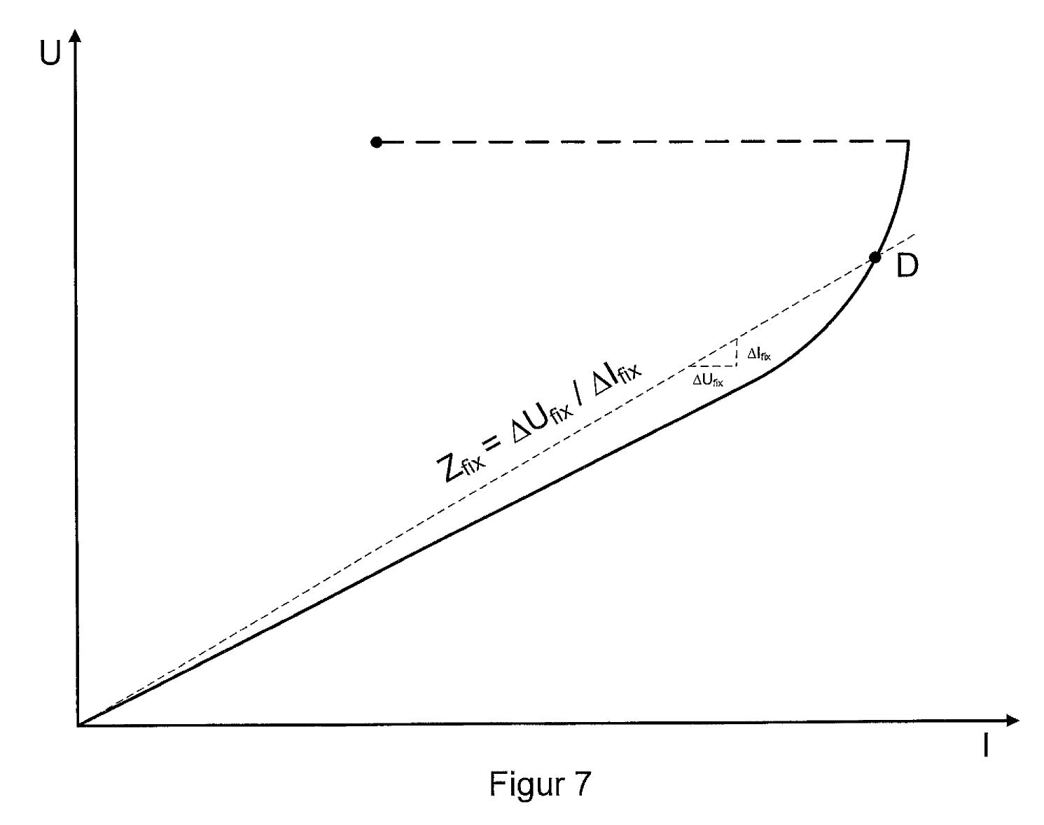

FIG. 7 shows a U/I characteristic curve at the input of the transformer 12 with a fixed impedance threshold value as the setpoint value for control according to the method disclosed in WO 2004/063560 A1, which is prior art, and

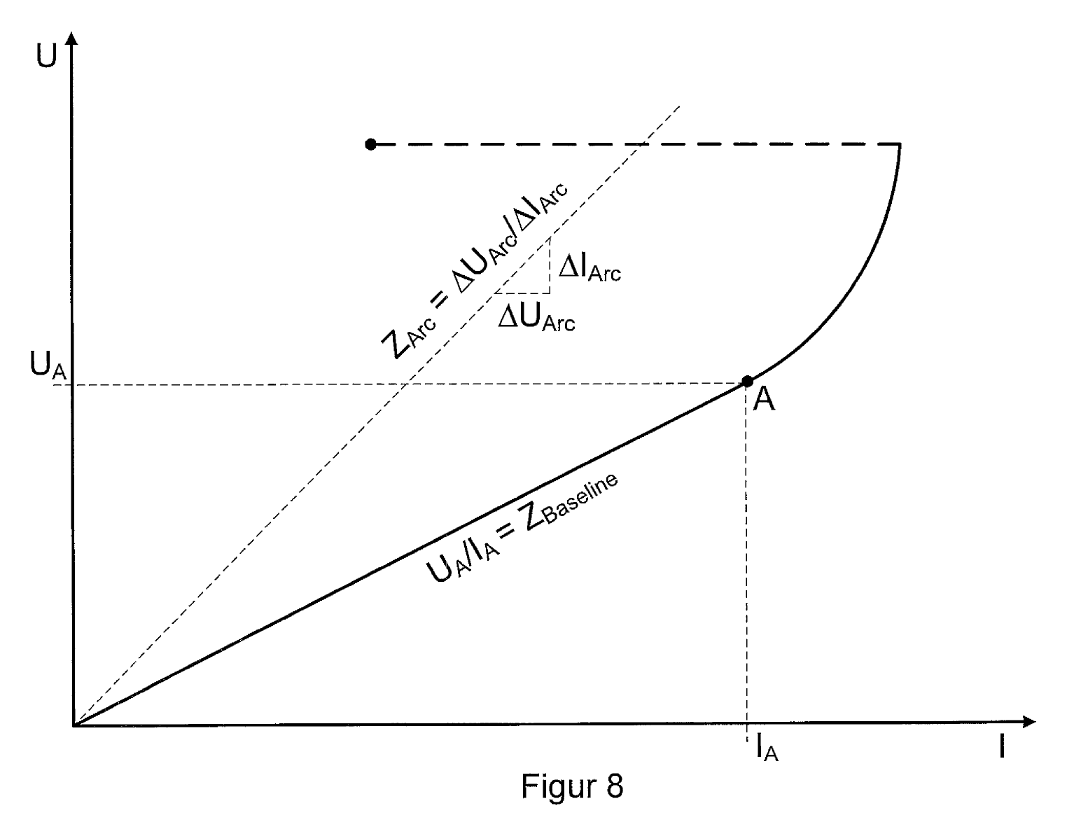

FIG. 8 shows a U/I characteristic curve at the input of the transformer 12 with a fixed impedance threshold value for detecting a spark discharge according to a method known from WO 2010/011838 A1.

FIG. 1 shows a combustion chamber 1 which is delimited by walls 2, 3, and 4 that are at ground potential. An ignition electrode 5 which is enclosed by an insulator 6 along a portion of the length thereof extends into combustion chamber 1 from above, and is guided through upper wall 2 into combustion chamber 1 in an electrically insulated manner by way of insulator 6. Ignition electrode 5 and walls 2 to 4 of combustion chamber 1 are part of a series oscillating circuit 7 which also includes a capacitor 8 and an inductor 9. Of course, series oscillating circuit 7 can also comprise further inductors and/or capacitors, and other components that are known to a person skilled in the art as possible components of series oscillating circuits.

A high-frequency generator 10 is provided for excitation of oscillating circuit 7, and comprises a dc voltage source 11 and a transformer 12 having a center tap 13 on the primary side thereof, thereby enabling two primary windings 14 and 15 to meet at center tap 13. Using a high-frequency switch 16, the ends of primary windings 14 and 15 opposite center tap 13 are connected to ground in alternation. The switching rate of high-frequency switch 16 determines the frequency with which series oscillating circuit 7 is excited, and can be changed. Secondary winding 17 of transformer 12 supplies series oscillating circuit 7 at point A. High-frequency switch 16 is controlled using a not-shown control loop such that the oscillating circuit is excited with the resonant frequency thereof. The voltage between the tip of ignition electrode 5 and walls 2 to 4 that are at ground potential is therefore at a maximum.

FIG. 2 shows a longitudinal cross section of a cylinder of an internal combustion engine equipped with the ignition device depicted schematically in FIG. 1. Combustion chamber 1 is limited by an upper wall 2 in the form of a cylinder head, a cylindrical circumferential wall 3, and top side 4 of a piston 18 which is equipped with piston rings 19 and can move back and forth in the cylinder.

Cylinder head 2 comprises a passage 20 through which ignition electrode 5 is guided in an electrically insulated and sealed manner. Ignition electrode 5 is enclosed along a portion of the length thereof by an insulator 6 which can be composed of a sintered ceramic, e.g. an aluminium oxide ceramic. Ignition electrode 5 extends via the tip thereof into combustion chamber 1 and extends slightly past insulator 6, although it could be flush therewith.

A few sharp-edged projections 21 can be provided on the top side of piston 18 in the environment of the tip of ignition electrode 5, which are used to locally increase the electric field strength between ignition electrode 5 and piston 18 situated opposite thereto. When oscillating circuit 7 is excited, a corona discharge forms primarily in the region between ignition electrode 5 and optionally provided projections 21 of piston 18, and can be accompanied by a more or less intensive charge carrier cloud 22.

A housing 23 is placed onto the outer side of cylinder head 2. Primary windings 14 and 15 of transformer 12, and high-frequency switch 16 interacting therewith, are located in a first compartment 24 of housing 23. A second compartment 25 of housing 23 contains secondary winding 17 of transformer 12 and the remaining components of series oscillating circuit 7, and, optionally, means for observing the behavior of oscillating circuit 7. An interface 26 can be used to establish a connection, for example, to a diagnostic unit 29 and/or an engine control unit 30.

FIG. 3 shows a U/I characteristic curve at the input of transformer 12 for locating and reaching a final value (setpoint value) U_{B} of the primary voltage, which is located slightly below the breakdown voltage U_{D}. U_{B} is approached via iteration using the formula

Uₙ=Z_{Baseline}*Iₙ₋₁*k (1)

In the formula, k is a factor that is greater than 1 and should be less than or equal to the quotient of the breakdown voltage U_{D} and the product of the breakdown current I_{D} and the baseline impedance Z_{Baseline}:

k≦U_{D}/(Z_{Baseline}*I_{D}).

The factor k can be determined in advance in a suitable manner for an engine of a specified version, and, in fact, as a function of the distance between ignition electrode 5 and piston 18 or—expressed another way—the position of the engine crankshaft driven by piston 18 or—expressed yet another way—the ignition angle. The factor k is determined in preliminary trials such that the iteration method implemented using the stated formula (1) converges toward a final value U_{B} of the voltage which is slightly less than the breakdown voltage U_{D}. The factor k, which is determined in preliminary trials, can be used for a series of identical engines. The convergence toward a suitable final value of the primary voltage U_{B} is insensitive to production tolerances and changes in baseline impedance caused, for example, by ageing, production tolerances of the ignition device, contamination of the ignition electrode, temperature differences due to different exhaust gas recirculation rates or different leanings of the fuel/air mixture, or due to the use of different control devices; it is also insensitive to changes in the design of the igniter, provided the geometry of the igniter and the ignition electrode inside the combustion chamber remain unchanged.

The iteration method is carried out for each cylinder of the engine in every cycle of the engine, i.e. once for every two revolutions of the crankshaft in the case of a 4-stroke engine, before the particular moment of ignition. To do this, first the baseline impedance Z_{Baseline} is determined in a linear part of the characteristic curve, below point A, preferably in the vicinity of point A, and, in fact, as the quotient of the primary voltage U and the associated primary current intensity I, e.g. as Z=U_{A}/I_{A}. The voltage Uₙ of the next iteration step in each case is determined using the formula (1). The primary voltage then converges toward the value U_{B}, and the intensity of the primary current converges toward the value I_{B}. Three iteration steps are sketched in FIG. 3 as examples. The final value U_{B} of the primary voltage is slightly less than the breakdown voltage U_{D}.

FIG. 4 shows the U/I characteristic curve at the input of transformer 12 and illustrates how a final value U_{B} of the primary voltage is approximated, wherein the approxmation takes place iteratively using the formula

Uₙ=Z_{Baseline}*Iₙ₋₁+U_{ADD} (2)

wherein U_{ADD} is an additional voltage that is slightly less than the difference between the breakdown voltage U_{D} and the primary voltage which is determined by the product of the baseline impedance Z_{Baseline} and the breakdown current I_{D}. The quantity U_{ADD} can be determined suitably using an engine having a specified configuration, and can then be applied for a series of identical engines. The convergence toward a suitable final value of the primary voltage U_{B} is insensitive to production tolerances and changes in the baseline impedance caused, for example, by ageing, production tolerances of the ignition device, contamination of the ignition electrode, temperature differences due to different exhaust gas recirculation rates or different leanings of the fuel/air mixture, or due to the use of different control devices; it is also insensitive to changes in the design of the igniter, provided the design and placement of the ignition electrode inside the combustion chamber remain unchanged.

The iteration method is carried out for each cylinder of the engine in every cycle of the engine, i.e. once for every two revolutions of the crankshaft in the case of a 4-stroke engine, before the particular moment of ignition. To do this, first the baseline impedance Z_{Baseline} is determined in the linear part of the U/I characteristic curve, as in the embodiment depicted in FIG. 3. The primary voltage Uₙ for iteration step n is determined by adding the additional voltage U_{ADD} to the product of the baseline impedance, which was just measured, and the intensity of the primary current Iₙ₋₁ measured in the previous iteration step n−1. The primary voltage Uₙ then converges toward the final value U_{B}, and the intensity of the primary current Iₙ converges toward the value I_{B}. Three iteration steps are shown as examples in FIG. 4.

FIGS. 5 and 6 show the U/I characteristic curve at the input point of transformer 12. The characteristic curve has a constant slope at low primary voltages of up to a voltage U_{A}. At primary voltages greater than U_{A}, the slope of the characteristic curve increases constantly until voltage breakdown occurs at voltage U_{D}.

In the example shown in FIG. 5, the primary voltage is increased incrementally, the intensity of the associated primary current I is measured, and the mean slope Zₙ₋₁=(Uₙ−Uₙ₋₁)/(Iₙ−Iₙ₋₁) is calculated for each step. The slope determined in this manner is compared with a specified limiting value of the slope and, if this limiting value is reached or exceeded, the iteration method is halted.

The limiting value of the slope can be determined suitably in preliminary trials, in particular such that it is the slope of the characteristic curve at point B, at which the primary voltage U_{B} is slightly less than the breakdown voltage U_{D}.

As shown in FIG. 5, the primary voltage is increased in uniform increments. However, it is also possible to increase the primary voltage in increments of decreasing size. The advantage thereof is that the desired final value U_{B} of the primary voltage can be approximated with greater accuracy.

The final value U_{B} can be suitably selected in preliminary trials as a function of the distance of the tip of ignition electrode 5 from piston 18 or—expressed another way—as a function of the position of the crankshaft or—expressed yet another way—as a function of the ignition angle, to obtain a corona of optimal size. An engine control unit can specify when ignition should take place in terms of the distance between the tip of ignition electrode 5 and piston 18, the position of the crankshaft, or the ignition angle, and, based thereon, one of the following is selected accordingly: the limiting value of the slope, per the example shown in FIGS. 5 and 6, the value U_{ADD}, per the embodiment shown in FIG. 4, or the factor k, per the embodiment depicted in FIG. 3. For this purpose, the values K or U_{ADD} or the limiting value of the slope are stored in a control unit as a function of the distance of the tip of ignition electrode 5 from piston 18, or the angular position of the crankshaft, or the ignition angle. The values can be stored in an engine control unit which is present anyway, although they are preferably stored in a separate ignition control unit.

The limiting value of the slope of the U/I characteristic curve shown in FIGS. 5 and 6 can be fixedly specified, although it can also be derived from a previously determined slope of the U/I characteristic curve in the linear part thereof, that is, from the baseline impedance. For instance, the limiting value of the slope of the U/I characteristic curve can be determined on the basis of the baseline impedance via addition of an additional impedance or by multiplying the baseline impedance by a factor. The advantage thereof is that greater changes in the baseline impedance can be accounted for in this manner when determining the limiting value of the slope of the U/I characteristic curve.

The factor by which the baseline impedance is multiplied to determine the limiting value, or the additional impedance that is added to the baseline impedance to determine the limiting value of the slope can be determined in preliminary trials as a function of the distance of the tip of the ignition electrode from the piston, or the position of the crankshaft, or the ignition angle. They are also stored in a control unit, and can be specified by same. The values can be stored in an engine control unit which is present anyway, although they are preferably stored in a separate ignition control unit.

In all variants of the method according to the invention described above, the situation is prevented in which the breakdown voltage U_{D} is reached or exceeded during operation of the engine, in contrast to the methods in the prior art: In the method known from WO 2004/063560 A1, the increase of the primary voltage is halted as soon as the measured impedance exceeds a fixed threshold value Z_{fix}, to reliably prevent a spark discharge from occurring. The impedance threshold value Z_{fix} must ensure that a corona occurs without an arc of a spark for various igniters. Since this must also apply for igniters having U/I characteristic curves with different shapes due to changes related to design or production, Z_{fix} must be selected relatively low. Therefore, the straight line representing the value Z_{fix} intersects the U/I characteristic curve at a point D far below the breakdown voltage U_{D}, see FIG. 7. The corona can therefore not reach the maximum size thereof in most cases.

According to the method described in WO 2010/011838 A1, the baseline impedance is first determined in the linear part of the characteristic curve. Next, the impedance is increased incrementally until a spark discharge is detected. A spark discharge is detected when the measured impedance exceeds a threshold value Z_{Arc}, see FIG. 8. After a spark discharge is detected, the impedance is reduced by a larger increment, thereby ensuring that a corona can be produced once more without a spark discharge in the subsequent engine cycles. However, the present invention prevents the need to create a spark discharge in order to obtain a corona discharge without a spark discharge in subsequent ignitions.

### LIST OF REFERENCE NUMERALS

1. Combustion chamber
2. Wall of the combustion chamber
3. Wall of the combustion chamber
4. Wall of the combustion chamber, top side of piston 18
5. Ignition electrode
6. Insulator
7. Oscillating circuit, series oscillating circuit
8. Capacitor
9. Inductor
10. High-frequency generator
11. dc voltage source
12. Transformer
13. Center tap
14. Primary winding
15. Primary winding
16. High-frequency switch
17. Secondary winding
18. Piston
19. Piston rings
20. Passage
21. Projections
22. Charge carrier cloud
23. Housing
24. First compartment of 23
25. Second compartment of 23
26. Interface
27. Input
28. Input
29. Diagnostic unit
30. Engine control unit

What is claimed is:

1. A method for igniting a fuel/air mixture in a cyclically operating internal combustion engine comprising one or more combustion chambers which are delimited by walls that are at ground potential, using an igniter,
wherein an electrical transformer having a baseline impedance that is characteristic for the selected ignition system on the primary side thereof is used to excite an electric oscillating circuit, which is connected to a secondary winding of the transformer and in which an ignition electrode, which extends through one of the walls delimiting the combustion chamber in an electrically insulated manner, constitutes a capacitance together with the walls of the combustion chamber that are at ground potential,
and wherein the excitation of the oscillating circuit is controlled such that a corona discharge igniting the fuel/air mixture is created in the combustion chamber at the ignition electrode, wherein before every moment of ignition of the internal combustion engine, the electric voltage applied at a primary winding of the transformer—referred to hereinbelow as primary voltage—is increased incrementally, wherein the increments by which the primary voltage is increased are selected such that the intensity of the electric current flowing in the primary winding—referred to hereinbelow as primary current—increases incrementally due to the stepwise increase in the applied primary voltage by amounts that become smaller as the impedance at the input point of the transformer increases, and moves toward a specifiable minimum upon approaching a voltage at which a voltage breakdown—referred to hereinbelow as breakdown voltage U_{D}—occurs in the oscillating circuit.

2. The method according to claim 1, wherein the minimum is zero.

3. The method according to claim 1, wherein the increase of the primary voltage is halted at the latest when the specifiable minimum of the amount, by which the intensity of the primary current increases as the primary voltage is increased incrementally, is reached or fallen below for the first time.

4. The method according to claim 1, wherein the increase of the primary voltage is halted when a limiting value of the amount by which the intensity of the primary current increases as the primary voltage increases in increments is reached or fallen below for the first time, wherein the limiting value lies above the minimum by a specifiable amount.

5. The method according to claim 1, wherein the baseline impedance Z_{Baseline} is redetermined before every ignition.

6. The method according to claim 1, wherein the primary voltage U is increased incrementally by applying an iteration method for calculating the primary voltage Uₙ for the nth step on the basis of the primary current having intensity Iₙ₋₁, which was induced by the primary voltage Uₙ₋₁ applied in the (n−1)th step, according to the formula Uₙ=Z_{Baseline}*Iₙ₋₁*k, wherein k>1.

7. The method according to claim 6, wherein k is selected such that it is less than or equal to the quotient of the breakdown voltage U_{D} and the product of the breakdown current I_{D} and the baseline impedance Z_{Baseline}, that is k U_{D}/(Z_{Baseline}*I_{D}).

8. The method according to claim 6, wherein the iteration method is halted when the increase Iₙ−Iₙ₋₁ in primary current intensity attained in a step n, or the increase Uₙ₊₁−Uₙ in primary voltage calculated on the basis thereof, reaches or falls below a specified limiting value.

9. The method according to claim 1, wherein the factor k is determined in advance in trials conducted on an igniter, and is then used for igniters of identical design.

10. The method according to claim 9, wherein the trials are carried out on an engine and are then applied for a series of identical engines.

11. The method according to claim 9, wherein for a piston engine, the factor k is determined as a function of the distance of the piston from the tip of the ignition electrode or the position of a crankshaft, or the ignition angle, is stored, and is used for the same types of igniters and identical engines as a function of the value of one of these three parameters in the equation Uₙ=Z_{Baseline}*Iₙ₋₁*k, wherein k changes only when the value of the selected parameter changes.

12. The method according to claim 1, wherein the primary voltage U is increased incrementally by applying an iteration method by calculating the primary voltage Uₙ for the nth step on the basis of the primary current having intensity Iₙ₋₁, which was induced by the primary voltage Uₙ₋₁ applied in the (n−1)th step, according to the formula
Uₙ=Z_{Baseline}*Iₙ₋₁+U_{ADD} (2)
wherein U_{ADD} is an additional voltage that is slightly less than the difference between the breakdown voltage U_{D} and the voltage determined by the product of the baseline impedance Z_{Baseline} and the breakdown current I_{D}.

13. The method according to claim 12, wherein the quantity U_{ADD} is determined in advance in trials conducted on an igniter, and is then used for igniters of identical design.

14. The method according to claim 13, wherein the trials are carried out on an engine and are then applied for a series of identical engines.

15. The method according to claim 13, wherein for a piston engine, the additional voltage U_{ADD} is determined as a function of the distance of the piston from the tip of the ignition electrode, or the position of a crankshaft, or the ignition angle, is stored, and is used in igniters of identical design and in identical engines as a function of one of these three parameters, in the equation
Uₙ=Z_{Baseline}*Iₙ₋₁+U_{ADD} (2)
wherein U_{ADD} changes only when the value of one of these three parameters changes.

16. The method according to claim 12, wherein the iteration method is halted when the increase Iₙ−Iₙ₋₁ in primary current intensity attained in a step n, or the increase Uₙ₊₁−Uₙ in primary voltage calculated on the basis thereof reaches or falls below a specified limiting value.

17. The method according to claim 1, wherein the primary voltage is increased incrementally from a value Uₙ to a value Uₙ₊₁ by applying an iteration method, the intensity of the primary current Iₙ₊₁ resulting therefrom is measured and compared to the current intensity Iₙ measured in the preceding step n, and, on the basis thereof, the mean slope of the U/I characteristic curve for the dependence of the primary current on the primary voltage is determined in the range between the nth step and the (n+1)th step, and the iteration method is halted when the mean slope that is determined reaches or exceeds a specified limiting value.

18. The method according to claim 17, wherein the mean slope of the U/I characteristic curve is determined as Zₐᵥ=(Uₙ₊₁−Uₙ)/(Iₙ₊₁−Iₙ).

19. The method according to claim 17, wherein the primary voltage is increased in uniform increments.

20. The method according to claim 15, wherein the primary voltage is increased in the non-linear part of the U/I characteristic curve by increments Uₙ₊₁−Uₙ.

21. The method according to claim 20, wherein the size of the increments decreases in a linear manner.

22. The method according to claim 18, wherein the limiting value of the slope of the U/I characteristic curve is derived from the baseline impedance Z_{Baseline} by increasing it by an additional impedance determined in preliminary trials, or by multiplication by a factor determined in preliminary trials, wherein the factor or the additional impedance is determined as a function of the distance of the tip of the ignition electrode from the piston, or the position of the crankshaft, or the ignition angle.
